(19) United States
(12) Patent Application Publication
(10) Pub. No.: US 2026/0012694 A1
(43) Pub. Date: Jan. 8, 2026

(54) EYE TRACKING DEVICE

(71) Applicant: Google LLC, Mountain View, CA (US)

(72) Inventors: Andrew Logan, Waterloo (CA); Oscar Alberto Martinez, San Diego, CA (US); Saeid Rezaei, Waterloo (CA); Philippe Bouchilloux, San Jose, CA (US); Jau Yu Chen, New Taipei City (TW); Clayton Merrill Kimber, Raharney (IE)

(21) Appl. No.: 19/129,275

(22) PCT Filed: Nov. 18, 2022
(86) PCT No.: PCT/US2022/080196

§ 371 Date: May 12, 2025

(51) Int. Cl. H04N 23/56; G06T 7/70; H04N 23/21; H04N 23/55

(52) U.S. Cl. CPC H04N 23/56; G06T 7/70; H04N 23/21; H04N 23/55; G06T 2207/10048; G06T 2207/30201

(57) ABSTRACT

A device may include a frameset having a front frame portion and two arm portions. A device may include a lens coupled to the front frame portion, the lens comprising a reflective coating that is reflective over a laser bandwidth. A device may include a laser flood illuminator positioned within a first arm portion of the two arm portions, the laser flood illuminator transmitting a beam having the laser bandwidth and configured to transmit the beam towards an eye via reflection at the lens. A device may include a camera comprising: a filter configured to receive a returned light from the eye and generate a returned filtered light, the filter having a passband that includes the laser bandwidth, and a sensor operable to receive the returned filtered light and generate a signal. A device may include a processor operable to measure the signal.

### TECHNICAL FIELD

This description relates to an eye tracking device.

### BACKGROUND

Eye tracking is used extensively in augmented reality, virtual reality, mixed reality, and medical applications. Eye trackers use a light source and a camera to measure eye positions and eye movements. Any combination of the position and shape of the pupil of the eye, and the rotational position (gaze direction) of the eye may be used to track the eye.

### SUMMARY

The present disclosure describes ways to provide a compact, efficient eye tracking device suitable for embedding in an arm portion of a frameset, for example a temple arm of a glasses frame. The eye tracking device includes a laser flood illuminator that can emit a beam, which in examples includes pulsed light in the near infrared. The beam is reflected off a surface, which in examples may comprise a lens with a near infrared reflective coating, to illuminate an eye of a user. The returned light from the scattered beam may be reflected off a surface, which in examples may be the same or a different lens of the example pair of glasses. The returned light may then be filtered to remove background light. The returned filtered light is then imaged by a detector inside a camera. In examples, the camera and laser flood illuminator may be positioned together within the same temple arm covered by a window. In examples, the window may be the same color as the areas of temple arm adjacent to the window. In this way, it is possible to create a more efficient and compact eye tracker which may be integrated into a wide variety of arm portions of framesets, including eyeglass temple arms.

In some aspects, the techniques described herein relate to an eye tracking device including: a frameset having a front frame portion and two arm portions; a lens coupled to the front frame portion, the lens including a reflective coating that is reflective over a laser bandwidth; a laser flood illuminator positioned within a first arm portion of the two arm portions, the laser flood illuminator transmitting a beam having the laser bandwidth and configured to transmit the beam towards an eye via reflection at the lens; and a camera including: a filter configured to receive a returned light from the eye and generate a returned filtered light, the filter having a passband that includes the laser bandwidth, and a sensor operable to receive the returned filtered light and generate a signal; and a processor operable to measure the signal.

In some aspects, the techniques described herein relate to a method for eye tracking, including: transmitting, via a laser flood illuminator, a beam having a laser bandwidth, the laser flood illuminator positioned within a first arm portion of a frameset having a front frame portion and two arm portions and configured to transmit the beam towards a lens; reflecting the beam towards an eye, via the lens, the lens being coupled to the front frame portion of the frameset and including a reflective coating reflective over the laser bandwidth; filtering, via a filter associated with a camera, a returned light from the eye to generate a returned filtered light, the filter having a passband that includes the laser bandwidth; generating a signal, via a sensor associated with the camera, based on the returned filtered light; and generate an image, via a processor, based on the signal.

In some aspects, the techniques described herein relate to a method for assembling an eye tracking device, including: coupling a lens to a front frame portion of a frameset having a front frame portion and two arm portions, the lens including a reflective coating reflective over a laser bandwidth; coupling a laser flood illuminator within a first arm portion of the two arm portions, the laser flood illuminator being operable to transmit a beam having a laser bandwidth towards an eye via reflection at the lens; and coupling a camera within one of the two arm portions, the camera including a filter configured to receive a returned light from the eye and generate a returned filtered light, the filter having a passband that includes the laser bandwidth, and a sensor operable to generate a signal based on the returned filtered light.

### BRIEF DESCRIPTION OF THE DRAWINGS

FIG. 1A depicts a head mounted device, according to examples described throughout this disclosure.

FIG. 1B depicts a head mounted device, according to examples described throughout this disclosure.

FIG. 1C depicts a block diagram of a head mounted device, according to examples described throughout this disclosure.

FIG. 2A depicts a perspective, pass-through view of an eye tracking device, according to examples described throughout this disclosure.

FIG. 2B depicts a detail of an eye tracking device, according to examples described throughout this disclosure.

FIG. 2C depicts a lens with a reflective coating, according to examples described throughout this disclosure.

FIG. 2D depicts a light return path of the eye tracking device, according to examples described throughout this disclosure.

FIG. 2E depicts a series of transmissivity curves for a filter overlaid with a laser bandwidth for reference, according to examples described throughout this disclosure.

FIG. 2F depicts a beam profile of a laser flood illuminator, according to examples described throughout this disclosure.

FIG. 2G depicts a two-dimensional field of illumination diagram, according to examples described throughout this disclosure.

FIG. 3A depicts a method, according to examples described throughout this disclosure.

FIG. 3B depicts a method, according to examples described throughout this disclosure.

### DETAILED DESCRIPTION

The present disclosure describes an eye tracking device. Eye tracking devices comprise at least one illumination source and one camera operable to measure light emitted from the illumination source and reflected off an eye. From the image data, a position of the pupil in an image of the eye may be determined and used to identify a gaze direction of a user. The gaze direction information may be used, for example, to determine where in a head mounted display to place content, or as part of the computations to generate foveated rendering. In examples, the image of the eye may be used in medical applications, training applications, or any other application.

Eye tracking works best when a clear image of the eye is available. For this reason, typically eye tracking illuminators and sensing devices are mounted on the front frame portion of a frameset in front of a user's eye, shining light directly on the eye.

In some examples, it may be preferable to use a frameset that resembles an ordinary set of glasses. Prior eye tracking devices are bulky, however, making those eye trackers very difficult to integrate into the frame front of the glasses. Integrating prior eye trackers into glasses frames requires the front of the frames to be bulky, restricting the range of industrial design options for the frames.

Prior eye tracking devices are sometimes not suitable for use with prescription lenses. Some lens prescription geometries are thick enough to extend beyond the frames, into the interior of the glasses frames, for example. If an eye tracker is mounted on the inside of a pair of glasses frames, lenses for some prescriptions may obstruct the eye tracker's ability to image the eye or require that the eye tracker look through the thickness of the lenses to image the eye.

The present disclosure describes an eye tracking device integrated into an arm portion of a frameset. The eye tracking device includes a laser flood illuminator that generates a beam within a laser bandwidth, a surface operable to reflect the beam towards and eye, a filter to remove a background light outside of the laser bandwidth, and a camera. The laser flood illuminator is positioned in an arm portion of the frameset, thereby moving some of the bulky components of the eye tracking device away from the front frame portion of the frameset and providing other advantages that are further described below.

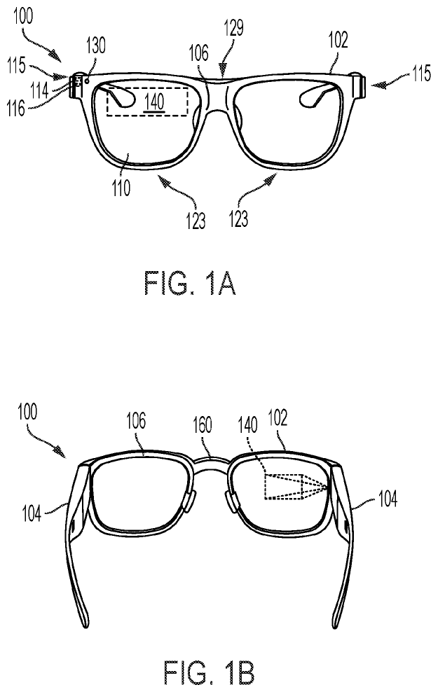

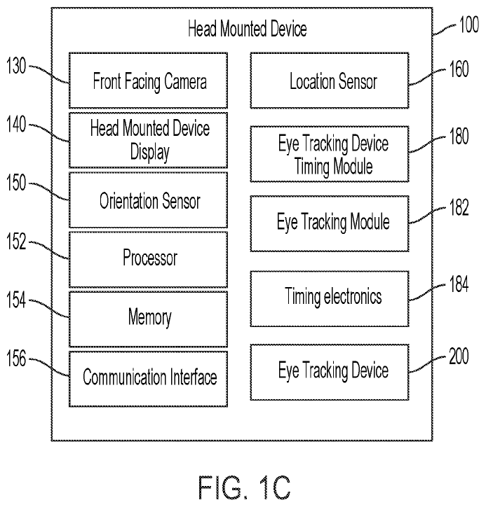

FIG. 1A depicts a frontal view and FIG. 1B depicts a rear view of a head mounted device 100, according to an examples shown, head mounted device 100 may be implemented as smart glasses (e.g., augmented reality, virtual reality, simulated reality, mixed reality, see-through reality, blended reality, or alternative reality glasses) configured to be worn on a head of a user. Head mounted device 100 may include display capability and computing/processing capability. In other examples, head mounted device 100 may comprise a virtual reality-type frameset.

The example head mounted device 100 includes a frameset with a front frame portion 102 and two arm portions 104, each respective arm portion being rotatably coupled to the front frame portion 102 by a hinge portions 115. In the example of FIGS. 1A and 1B, front frame portion 102 includes rim portions 123 surrounding respective optical portions in the form of lenses (including lens 110), the rim portions 124 being coupled together by a bridge portion 129 configured to rest on the nose of a user. The two arm portions 104 are coupled, for example, pivotably or rotatably coupled, to the front frame portion 102 at peripheral portions of the respective rim portions 123. In some examples, the lenses are corrective/prescription lenses. In some examples, the lenses 127 are an optical material including glass and/or plastic portions that do not necessarily incorporate corrective/prescription parameters.

In augmented reality examples, user may view the world through the left lens and the right lens. In virtual reality applications, however, front frame portion 102 may include a display area that is opaque to the world beyond the headset. In virtual reality applications, two arm portions 104 may be part of a cover around the display connected to straps that keep the frameset in place on a user's head.

Head mounted device 100 includes a head mounted device display 140 configured to display information (e.g., text, graphics, image, etc.) for one or both eyes. Head mounted device display 140 may cover all or part of front frame portion 102 of head mounted device 100. Head mounted device display 140 may include one or both of the left and right lens (of which lens 110 is one).

In examples, head mounted device 100 may include other sensing devices besides the eye tracking device. For example, the head mounted device 100 may include at least one front facing camera 130. Front facing camera 130 may be directed towards a front field-of-view or can include optics to route light from a front field of view to a sensor.

In examples, head mounted device 100 may further include at least one orientation sensor implemented as any combination of accelerometers, gyroscopes, and magnetometers combined to form an inertial measurement unit (i.e., IMU) to determine an orientation of a head mounted device.

In examples, head mounted device 100 may further comprise a microphone 114 and/or a speaker 116.

FIG. 1C depicts a block diagram of head mounted device 100, according to an example. Head mounted device 100 may include any combination of components depicted in FIGS. 1A, 1B, and 1C. In FIG. 1C, example head mounted device 100 is depicted as including a front facing camera 130, a head mounted device display 140, an orientation sensor 150, a processor 152, a memory 154, a communications interface 156, a location sensor 160, an eye tracking device timing module 180, eye tracking module 182, a timing electronics 184, and an eye tracking device 200.

Head mounted device 100 includes a processor 152 and a memory 154. In examples, processor 152 may include multiple processors, and memory 154 may include multiple memories. Processor 152 may be in communication with any cameras, sensors, and other modules and electronics of head mounted device 100. Processor 152 is configured by instructions (e.g., software, application, modules, etc.) to display content or execute any modules included on head mounted device 100. The instructions may include non-transitory computer readable instructions stored in, and recalled from, memory 154. In examples, the instructions may be communicated to processor 152 from a computing device or from a network (not pictured) via a communications interface 156.

Processor 152 of head mounted device 100 is in communication with head mounted device display 140. Processor 152 may be configured by instructions to transmit text, graphics, video, images, etc. to head mounted device display 140.

Communications interface 156 of head mounted device 100 may be operable to facilitate communication between head mounted device 100 and other computing devices, such as desktop computers, laptop computers, tablet computers, smart phones, wearable computers, servers, or any other type of computing device. In examples, communications interface 156 may utilize Bluetooth, Wi-Fi, Zigbee, or any other wireless or wired communication methods.

In examples, processor 152 of head mounted device 100 may be configured with instructions to execute eye tracking device timing module 180. Eye tracking device timing module 180 may be operable to time the emission of laser flood illuminator pulses with integrations of a detector within a camera, as further described below.

In examples, processor 152 of head mounted device 100 may be configured with instructions to execute eye tracking module 182. Eye tracking module 182 may be operable to perform any combination of the following functions: receive a signal from a detector associated with a camera, measure the signal from the detector to generate one or more images of an eye, receive one or more images of an eye, and determine the direction of a gaze or a series of gazes of a user's eye, as further described below

In examples, head mounted device 100 may include a timing electronics 184. Timing electronics 184 may include hardware operable to facilitate the coordination of pulses emitted from a laser flood illuminator, as further described below.

Head mounted device 100 includes an eye tracking device 200. Eye tracking device 200 includes a frameset 106, a laser flood illuminator 206, a reflective surface (for example lens 110), and a camera 216 including a filter 214 and a sensor 217. In examples, eye tracking device 200 may further include an electronics and camera 216 may include structured optics 212.

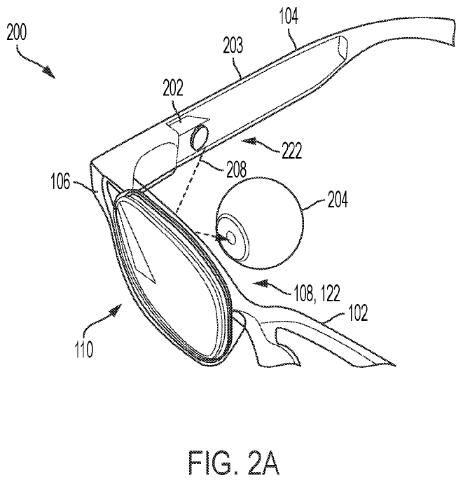

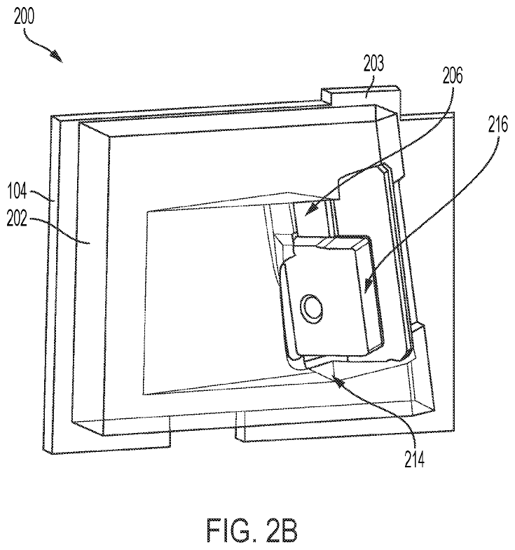

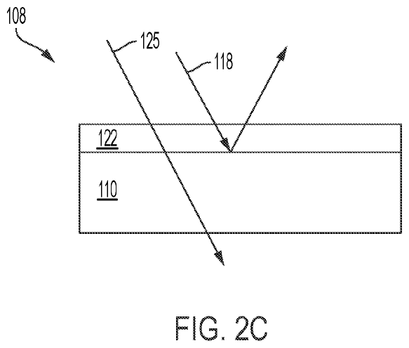

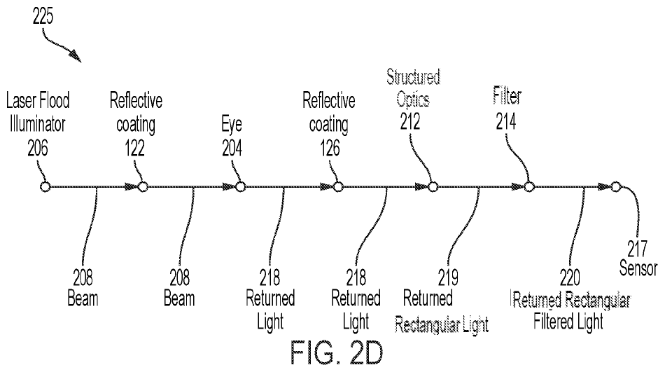

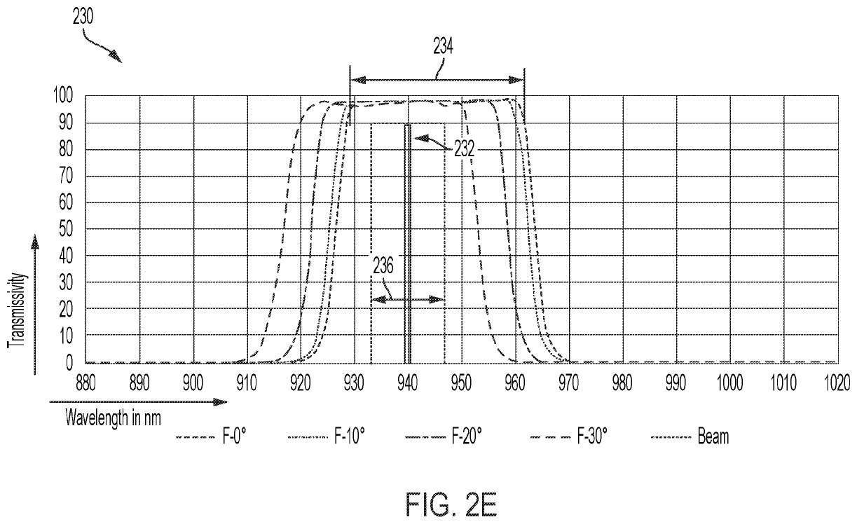

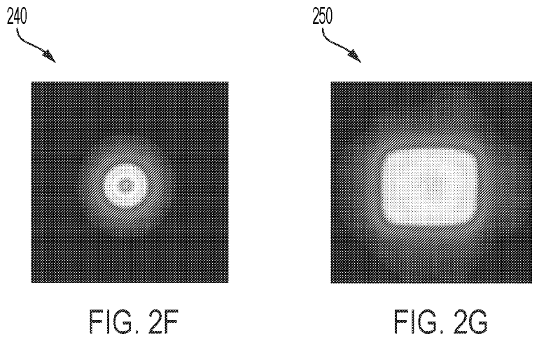

FIGS. 2A-2E depict various features of eye tracking device 200. FIG. 2A depicts a perspective view of eye tracking device 200 coupled to frameset 106, according to an example. FIG. 2B depicts eye tracking device 200 embedded inside a first arm portion 203 of two arm portions 104 of frameset 106, according to an example. FIG. 2C depicts a filter bandpass overlaid with a laser bandwidth, according to an example. FIG. 2D depicts a light return path, according to an example. FIG. 2E depicts a series of transmissivity curves for a filter overlaid with a laser bandwidth for reference. FIGS. 2F and 2G each depict a beam profile, according to an example.

Turning to FIG. 2A, frameset 106 comprising front frame portion 102 and two arm portions 104 may be seen. Eye tracking device 200 is positioned inside first arm portion 203. An eye 204 is positioned behind front frame portion 102 for demonstration purposes.

Laser flood illuminator 206 is positioned within first arm portion 203. Laser flood illuminator 206 is operable to transmit beam 208 having a laser bandwidth towards a lens 110. Laser flood illuminator 206 is a laser that generates light in the infrared to visible range that is substantially uniform over a spatial target area. In examples, laser flood illuminator 206 may be a narrow bandwidth laser. In examples, laser flood illuminator 206 may have a laser bandwidth of approximately 1 nm, providing for a more efficient laser flood illuminator 206. In examples, laser flood illuminator 206 may emit pulsed light. By selecting a laser flood illuminator 206 that pulses light with a sufficiently narrow laser bandwidth, it may be possible to provide relatively high peak power, irradiance or radiant intensity to obtain adequate signal-to-noise for eye tracking while also using less battery power. In examples, the peak power may be between 0.5-1 W, with an average power below 5 mW. In examples, laser flood illuminator 206 may emit light with a peak irradiance of approximately 0.7 W/m². In examples, laser flood illuminator 206 may emit light with a peak radiant intensity of approximately 250 mW/sr. Using less battery power to obtain an adequate signal-to-noise ratio may allow for a smaller battery to operate eye tracking device 200, which may in turn allow for a more compact and lower temperature eye tracking device 200. A more compact eye tracking device 200 may allow for the eye tracking device 200 to be placed in one or more sections of two arm portions 104 instead of front frame portion 102. The more compact eye tracking device 200 may also allow for two arm portions 104 to be more trim, enabling a further range of frame styles to be used with head mounted device 100.

In examples, the laser bandwidth of laser flood illuminator 206 may be within the near infrared (NIR) spectrum. NIR light may refer to light with a wavelength between about 750 nm to about 2500 nm. In examples, the laser bandwidth of laser flood illuminator 206 may be within the infrared (IR) spectrum. IR light may refer to light with a wavelength between about 1 mm to 750 nm. By selecting laser bandwidth within the NIR spectrum or the IR spectrum, it may be possible to provide an eye tracking device 200 that does not emit light that is noticeable to the user.

In examples, laser flood illuminator 206 may comprise a vertical cavity surface emitting laser, or VCSEL. A VCSEL is a type of semiconductor laser diode with laser beam emission perpendicular from the top surface, as opposed to conventional edge-emitting semiconductor lasers. VCSELs include a larger output aperture compared to edge-emitting lasers, producing a lower divergence angle of the output beam. By making laser flood illuminator 206 a VCSEL, it may be possible to illuminate only the parts of eye 204 needed to do eye tracking. Avoiding off-target illumination may allow for an even lower powered laser flood illuminator 206 that can provide the adequate signal-to-noise ratio needed to perform eye tracking. Moreover, because VCSELs emit from the top surface of the chip, they can be tested on-wafer before they are cleaved into individual devices. Selecting a VCSEL to use for laser flood illuminator 206 may therefore reduce the fabrication cost of eye tracking device 200.

Turning to FIG. 2B, it may be seen that in examples eye tracking device 200 may further include a housing 202. Housing 202 may comprise any structure onto which portions of eye tracking device 200 may be coupled. In examples, housing 202 may be an additional structure that is inserted into first arm portion 203. In examples, housing 202 may be a molded plastic carrier designed to be coupled to an exterior of or into a cavity formed within one of two arm portions 104.

In examples, lens 110 may be transparent to visible spectrum light. For example, FIG. 2C depicts reflective surface 108, according to an example. Reflective surface 108 may include a lens 110 and a reflective coating 122.

In examples, reflective coating 122 may comprise an optical coating through which some light may be transmitted substantially unaffected while at least some of the laser bandwidth is reflected. For example, reflective coating 122 may allow visible spectrum light 125 to pass and a bandwidth of NIR or IR light 118 to be reflected. Visible light may refer to light with a wavelength between about 380 nm to about 750 nm. In examples, reflective coating 122 may be positioned on the eye side of lens 110. However, the coating 122 may also be arranged on the other side of lens 110, i.e., on the side of lens 110 that faces away from the user's eye.

In examples, reflective coating 122 may comprise a variation of an anti-reflective coating. In examples, reflective coating 122 may comprise a specialized dichromatic beam splitter reflective to NIR and/or IR light, while allowing visible light to pass through. For example, reflective coating 122 may comprise a NIR reflective coating.

In examples, reflective coating 122 may cover all or only a portion of the surface on the eye-side of lens 110.

Returning to FIG. 2A, it may be seen that beam 208 emitted from eye tracking device 200 at first arm portion 203 is reflected off reflective coating 122 to illuminate eye 204. Beam 208 is scattered at eye 204, generating returned light, i.e., the second lens of head mounted device 100.

FIG. 2D depicts a light return path 225, according to an example. Light return path 225 depicts the journey that light takes in eye tracking device 200 between laser flood illuminator 206 and sensor 217. Light return path 225 depicts beam 208 being emitted from laser flood illuminator 206, reflected off of reflective coating 122, and incident on eye 204. At eye 204, beam 208 is scattered, generating returned light 218. Returned light 218 is reflected off a reflective coating 126. In examples, reflective coating 126 may be the same as reflective coating 122. In further examples, however, reflective coating 126 may be different from reflective coating 122. For example, reflective coating 126 may be applied to the lens opposite to lens 110.

Eye tracking device 200 further includes camera 216. Camera 216 includes a filter 214. In examples, filter 214 may, for example, be coupled to an aperture of camera 216. Filter 214 is operable to receive returned light 218 scattered from eye 204 and allow returned filtered light 219 to pass. Filter 214 selectively only transmits light in a filter passband that includes at least the laser bandwidth. For example, the FWHM bandwidth of the filter includes at least a portion of the laser bandwidth or the entire laser bandwidth. By filtering out at least some light outside of the laser bandwidth, filter 214 may increase the signal-to-noise ratio of eye tracking device 200. In examples, filter 214 may be a narrow bandpass filter. In an example, filter 214 may comprise a thin film or interference filter with a nominal center wavelength of 940 nm with a full width half max of 20 nm.

In examples, filter 214 may be selected based on the center wavelength, linewidth, and distribution of laser flood illuminator 206, the incidence angles of light upon the filter (for example between 0 and 30 degrees), and the anticipated performance variation due to environmental factors such as temperature. For example, turning to FIG. 2E, which depicts a series of transmissivity curves 230 for filter 214 overlaid with a laser bandwidth 232 for reference, in accordance with an example. The x-axis of FIG. 2E represents wavelength in nanometers and the y-axis represents transmissivity. In the example, laser flood illuminator 206 has a laser bandwidth 232 of 1 nm. FIG. 2E is overlaid with a laser output variability range 236 of approximately 12 nm centered on 940 nm, however, which accounts for the temperature variability within the normal span of operating temperatures of the laser.

Transmissivity curves 230 depicts four transmissivity curves for a single filter “F” at 4 different angles of incidence: F-0°, F-10°, F-20°, and F-30° to account for the range of movement of the eye. Filter 214 has a filter passband width 234. In examples, filter passband width 234 may comprise the full width half max of the bandpass. Filter passband width 234 is 32 nm in the example of FIG. 2E.

In the example, a laser bandwidth of 1 nm and a filter passband of 32 nm are both centered on approximately 940 nm, allowing substantially all of returned light 218 in laser output variability range 236 to pass through filter 214 while preventing much of the light outside of laser output variability range 236 from passing. This may allow laser bandwidth 232 to pass through filter 214 for a reasonable range of operating temperatures and angles of light incidence, while preventing most background noise from passing. Filter 214 may further improve the signal to noise ratio for eye tracking device 200. In examples, filter passband width 234 may equal between 15-35, 20-30, 25-35, or 32 times laser bandwidth 232. In examples, filter passband width 234 may be between 15-35, 20-30, 25-35, or 32 nm wide and include the laser bandwidth.

In the example where laser flood illuminator 206 comprises a VCSEL, which tend to have narrow and thermally stable emission bandwidths, this may allow for filter 214 to comprise a standard narrow band filter, thereby rejecting ambient light while maximally passing eye tracking device 200 system light.

Camera 216 may further comprise structured optics 212. Returning to FIG. 2D, it may be seen that structured optics 212 may be positioned before filter 214 and sensor 217. Structured optics 212 are operable to receive returned light 218 comprising a circular beam profile and reshape the beam profile into a returned rectangular light 219. In examples, structured optics 212 may be incorporated into an aperture or a lens of camera 216. Returned rectangular light 219 may comprise a rectangular emission that can better match a rectangular sensor within camera 216 versus the circular beam profile of returned filtered light 219. For example, FIG. 2F depicts a beam profile 240 of beam 208 from laser flood illuminator 206, according to an example. As may be seen, beam profile 240 is substantially circular, or conical in shape. FIG. 2G depicts a beam profile 250 of returned rectangular light 219 generated by structured optics 212, which may better match a rectangular two-dimensional detector array within camera 216. In other examples, structured optics 212 may be positioned between filter 214 and sensor 217.

By passing the returned light through structured optics 212 before light is received at sensor 217, returned filtered light 219 may be better aligned to the field of view of camera 216, thereby substantially illuminating only the detector. Structured optics 212 may therefore allow for greater electrical to optical conversion efficiency in eye tracking device 200.

In examples, structured optics 212 may comprise a micro lens array. A micro lens array is a two-dimensional array of micro lenses, typically a few tens of micrometers in size and pitch, which are formed on a substrate. In examples, the micro lenses may be formed via etching, or via any other technique. The micro lens array may be arranged periodically (for example square or hexagonal) or pseudo-randomly. By using a micro lens array for structured optics 212, it may be possible to increase the light collection efficiency of a sensor, avoiding wasting light that may otherwise fall onto non-sensitive areas of the sensor.

In examples, structured optics 212 may comprise diffusers or other structured light optics operable to change the illumination pattern of returned filtered light 219 to better match a detector within camera 216.

Eye tracking device 200 further includes sensor 217. Sensor 217 is positioned to detect returned filtered light 219 (or rectangular returned filtered light 220 in the example where eye tracking device 200 includes structured optics 212). Sensor 217 is operable to provide a signal proportional to the amount of light that falls incident upon it. In examples, sensor 217 may comprise a global shutter CMOS image sensor. In examples, sensor 217 may comprise a two-dimensional charge-coupled device (CCD) array detector. In examples, sensor 217 may comprise any other type of detector.

The signal provided by sensor 217 may be used by processor 152 to measure returned filtered light 219 and generate a two-dimensional image of eye 204 from which eye tracking information can be derived. In examples, the signal may be digitized and converted to one or more images by processor 152. The one or more images may be used by eye tracking device timing module 180 to determine an eye gaze direction.

Returning to FIG. 2B, it may be seen that camera 216 may also be included in first arm portion 203. In other examples, however, camera 216 may be coupled an opposing arm portion of two arm portions 104 from laser flood illuminator 206. In this case, the beam 208 emitted from laser flood illuminator 206 may be reflected off a first one of the lenses 110, while the return light 218 may be reflected off the second one of the lenses 110 towards the camera 216.

In examples, laser flood illuminator 206 may emit pulses that are synchronized with measurements of signal from sensor 217. For example, eye tracking device 200 may include a timing electronics 184. Timing electronics 184 may be an FPGA, ASIC, or other device. Timing electronics 184 may include a pulse generator that may be utilized as a master clock by eye tracking device 200. For example, a leading edge from the pulse generator may be used by timing electronics 184 to substantially sync pulses emitted from laser flood illuminator 206 with exposure times for sensor 217. The incoming strobe pulses from the pulse generator may be used to ensure the length and timing of pulses emitted from laser flood illuminator 206 and signal produced by sensor 217 is within bounds and properly enabled. In examples, the incoming strobe pulses from the pulse generator may be routed to other components to trigger other devices or systems as well.

Returning to FIG. 2A, it may be seen that, in examples, first arm portion 203 may include a window 222 that is transparent to laser bandwidth 232. In examples, window 222 may be substantially the same color as a section of two arm portions 104 of frameset 106 adjacent to the housing, allowing the window to blend into frameset 106. This may be seen in FIG. 2A, where window 222 is positioned flush with the surface of with first arm portion 203 over laser flood illuminator 206. Window 222 may block visible light and allow NIR or IR light to pass, thereby hiding eye tracking device 200 within head mounted device 100, allowing frameset 106 to take on the appearance of a normal pair of glasses.

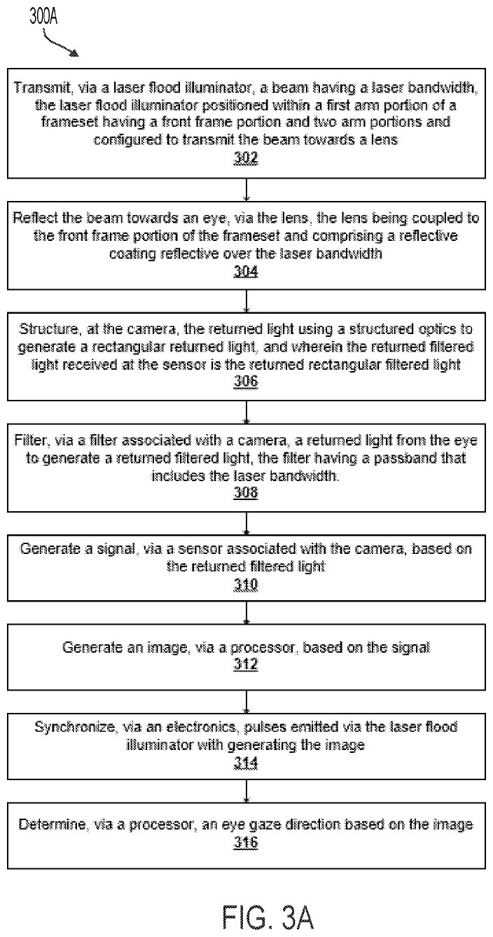

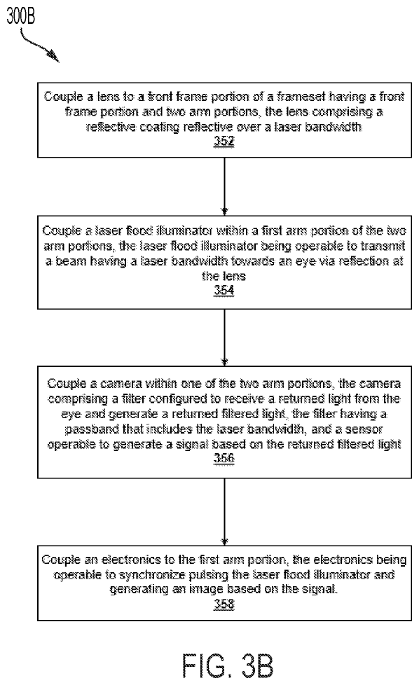

FIG. 3A depicts method 300A and FIG. 3B depicts method 300B, in accordance with examples of the disclosure.

Method 300A may be used to provide eye tracking functionality for head mounted device 100. Method 300A may include any combination of steps 302 to 316. Method 300A begins with step 302. In step 302, laser flood illuminator 206 may transmit beam 208 having a laser bandwidth, laser flood illuminator 206 being positioned within first arm portion 203 of frameset 106 having front frame portion 102 and two arm portions 104 and configured to transmit beam 208 towards lens 110, as described above.

Method 300A may continue with step 304. In step 304, beam 208 may be reflected towards eye 204, via lens 110, lens 110 being coupled to front frame portion 102 of frameset 106 and comprising reflective coating 122 reflective over the laser bandwidth as described above.

Method 300A may continue with step 306. In step 306, returned light 218 may be structured, at camera 216, using structured optics 212 to generate rectangular returned light 219, and the returned filtered light received at sensor 217 may be returned rectangular filtered light 220, as described above.

Method 300A may continue with step 308. In step 308, returned light 218 from eye 204 may be filtered via filter 214 associated with camera 216, to generate a returned filtered light, filter 214 having a passband that includes laser bandwidth 232, as described above.

Method 300A may continue with step 310. In step 310, a signal may be generated, via sensor 317 associated with camera 206, based on returned filtered light 219, as described above.

Method 300A may continue with step 312. In step 312, an image may be generated, via processor 152, based on the signal, as described above.

Method 300A may continue with step 314. In step 314, pulses emitted via laser flood illuminator 206 may be synchronized, via an electronics, with generating the image, as described above.

Method 300A may continue with step 316. In step 316, an eye gaze direction may be determined, via processor 152, based on the image, as described above.

Method 300B of FIG. 3B may be used to assemble an eye tracking device. Method 300B may include any combination of steps 352 to 358. Method 300B begins with step 352. In step 352, lens 110 may be coupled to front frame portion 102 of frameset 106 having front frame portion 102 and two arm portions 104, lens 110 comprising reflective coating 122 reflective over laser bandwidth 232, as described above.

Method 300B begins with step 354. In step 354, laser flood illuminator 206 may be coupled within first arm portion 203 of two arm portions 104, laser flood illuminator 206 being operable to transmit beam 208 having laser bandwidth 232 towards eye 204 via reflection at lens 110, as described above.

Method 300B begins with step 356. In step 356, Couple camera 216 within one of two arm portions 104, camera 216 comprising filter 214 configured to receive a returned light 218 from eye 204 and generate returned filtered light 219, filter 214 having a passband that includes laser bandwidth 232, and sensor 317 operable to generate a signal based on returned filtered light 219, as described above.

Method 300B begins with step 358. In step 358, an electronics may be coupled to first arm portion 203, the electronics being operable to synchronize pulsing laser flood illuminator 206 and generating an image based on the signal, as described above.

The disclosure of the Application describes a high efficiency eye tracking device that uses less power, enabling a smaller battery, and therefore allowing for a more compact eye tracking device with adequate a signal to noise ratio. The more compact eye tracking device hardware can be placed in the arm portions of a frameset frame, which may include the temple arms of a pair of glasses. The compact eye tracking device design may therefore allow for increased flexibility for the industrial design of the front of the glasses frames. The eye tracking device therefore provides reduced power usage without sacrificing the signal to noise ratio of the eye images.

Various examples of the systems and techniques described here can be realized in digital electronic circuitry, integrated circuitry, specially designed ASICs (application specific integrated circuits), computer hardware, firmware, software, and/or combinations thereof. These various examples can include examples in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various examples of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above examples are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing examples. Examples, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms includes, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative examples, the functions/acts noted may occur out of the order noted in the FIGS. For example, two FIGS. shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The examples are not limited by these aspects of any given examples.

Lastly, it should also be noted that whilst the accompanying claims set out particular combinations of features described herein, the scope of the present disclosure is not limited to the particular combinations hereafter claimed, but instead extends to encompass any combination of features or examples herein disclosed irrespective of whether or not that particular combination has been specifically enumerated in the accompanying claims at this time.

In some aspects, the techniques described herein relate to an eye tracking device, wherein the camera is positioned within the first arm portion.

In some aspects, the techniques described herein relate to an eye tracking device, wherein the laser flood illuminator is a vertical-cavity surface-emitting laser.

In some aspects, the techniques described herein relate to an eye tracking device, wherein the filter has a filter passband width that is between 15-35 nm wide.

In some aspects, the techniques described herein relate to an eye tracking device, wherein the laser bandwidth is within a near infrared spectrum and the reflective coating is a near infrared reflective coating.

In some aspects, the techniques described herein relate to an eye tracking device, wherein the first arm portion further includes a window covering the laser flood illuminator, the window being transparent to the laser bandwidth and substantially a same color as a section of the first arm portion adjacent to the window.

In some aspects, the techniques described herein relate to an eye tracking device, wherein the camera further includes: a structured optics operable to receive the returned light and generate a rectangular returned light, and wherein the returned filtered light received at the sensor is a returned rectangular filtered light.

In some aspects, the techniques described herein relate to an eye tracking device, wherein the eye tracking device further includes: an electronics operable to synchronize pulsing the laser flood illuminator with measuring the signal.

In some aspects, the techniques described herein relate to a method for eye tracking, further including: determining, via a processor, an eye gaze direction based on the image.

In some aspects, the techniques described herein relate to a method, wherein the camera is positioned within the first arm portion.

In some aspects, the techniques described herein relate to a method, wherein the laser flood illuminator is a vertical-cavity surface-emitting laser.

In some aspects, the techniques described herein relate to a method, wherein the filter has a filter passband width that is between 15-35 nm wide.

In some aspects, the techniques described herein relate to a method, wherein the laser bandwidth is within a near infrared spectrum and the reflective coating is a near infrared reflective coating.

In some aspects, the techniques described herein relate to a method, wherein the first arm portion further includes a window covering the laser flood illuminator, the window being transparent to the laser bandwidth and substantially a same color as a section of the first arm portion adjacent to the window.

In some aspects, the techniques described herein relate to a method, further including: structuring, at the camera, the returned light using a structured optics to generate a rectangular returned light, and wherein the returned filtered light received at the sensor is a returned rectangular filtered light.

In some aspects, the techniques described herein relate to a method, further including: synchronizing, via an electronics, pulses emitted via the laser flood illuminator with generating the image.

In some aspects, the techniques described herein relate to a method, wherein the one of the two arm portions the camera is positioned within is the first arm portion.

In some aspects, the techniques described herein relate to a method, wherein the laser flood illuminator is a vertical-cavity surface-emitting laser.

In some aspects, the techniques described herein relate to a method, wherein the filter has a filter passband width that is between 15-35 nm wide.

In some aspects, the techniques described herein relate to a method, wherein the laser bandwidth is within a near infrared spectrum and the reflective coating is a near infrared reflective coating.

In some aspects, the techniques described herein relate to a method, wherein the first arm portion further includes a window covering the laser flood illuminator, the window being transparent to the laser bandwidth and substantially a same color as a section of the first arm portion adjacent to the window.

In some aspects, the techniques described herein relate to a method, wherein the camera further includes a structured optics positioned between the filter and the sensor, the structured optics operable to receive the returned light and generate a rectangular returned light, and wherein the returned filtered light received at the sensor is a returned rectangular filtered light.

In some aspects, the techniques described herein relate to a method, further including: coupling an electronics to the first arm portion, the electronics being operable to synchronize pulsing the laser flood illuminator and generating an image based on the signal.

1. An device comprising:
a frameset having a front portion and an arm portion;
a lens coupled to the front portion, the lens comprising a coating that is reflective over a bandwidth;
an illuminator positioned within the arm portion, the illuminator configured to transmit a beam having the bandwidth and configured to transmit the beam towards an eye via reflection at the lens; and
a camera comprising:
a filter configured to filter a light from the eye into a filtered light, the filter having a passband that includes the bandwidth, and
a sensor configured to measure the filtered light.

2. The device of claim 1, wherein the camera is positioned within the arm portion.

3. (canceled)

4. The device of claim 1, wherein the filter has a filter passband width that is between 15-35 nm wide.

5. The device of claim 1, wherein the bandwidth is within a near infrared spectrum and the coating is a near infrared coating.

6. The device of claim 1, wherein the arm portion further comprises a window covering the illuminator, the window being transparent to the bandwidth and substantially a same color as a section of the arm portion adjacent to the window.

7. The device of claim 1, wherein the camera further comprises:
a structured optics operable to receive the light and generate a rectangular light, and wherein the filtered light received at the sensor is a rectangular filtered light.

8. The device of claim 1, wherein the device further comprises:
an electronics operable to synchronize pulsing the illuminator with measuring the filtered light.

9. A method, comprising:
transmitting, via an illuminator, a beam having a bandwidth, the illuminator positioned within an arm portion of a frameset having a front portion and configured to transmit the beam towards a lens;
reflecting the beam towards an eye, via the lens, the lens being coupled to the front portion of the frameset and comprising a coating reflective over the bandwidth;
filtering, via a filter associated with a camera, a light from the eye to generate into a filtered light, the filter having a passband that includes the bandwidth;
measuring a signal, via a sensor associated with the camera, based on the filtered light; and
generating an image, via a processor, based on the signal.

10. The method of claim 9, further comprising:
determining, via a processor, an eye gaze direction based on the image.

11. The method of claim 9, wherein the camera is positioned within the arm portion.

12. (canceled)

13. The method of claim 9, wherein the filter has a width that is between 15-35 nm wide.

14. The method of claim 9, wherein the bandwidth is within a near infrared spectrum and the reflective coating is a near infrared coating.

15. The method of claim 9, wherein the arm portion further comprises a window covering the illuminator, the window being transparent to the bandwidth and substantially a same color as a section of the first-arm portion adjacent to the window.

16. The method of claim 9, further comprising:
structuring, at the camera, the light using a structured optics to generate a rectangular light, and wherein the filtered light received at the sensor is a rectangular filtered light.

17. (canceled)

18. A method for assembling a device, comprising:
coupling a lens to a front portion of a frameset having a front portion and two arm portions, the lens comprising a coating reflective over a bandwidth;
coupling a illuminator within a arm portion, the illuminator configured to transmit a beam having a bandwidth towards an eye via reflection at the lens; and
coupling a camera within one of the two arm portions, the camera comprising a filter configured to filter a light from the eye into a filtered light, the filter having a passband that includes the bandwidth, and a sensor operable to measure a signal based on the filtered light.

19. The method of claim 18, wherein the one of the two arm portions the camera is positioned within is the arm portion.

20. (canceled)

21. The method of claim 18, wherein the filter has a width that is between 15-35 nm wide.

22. The method of claim 18, wherein the bandwidth is within a near infrared spectrum and the coating is a near infrared coating.

23. The method of claim 18, , wherein the arm portion further includes a window covering the illuminator, the window being transparent to the bandwidth and substantially a same color as a section of the first-arm portion adjacent to the window.

24. The method of claim 18, wherein the camera further comprises a structured optics positioned between the filter and the sensor, the structured optics operable to receive the returned light and generate a rectangular light, and wherein the filtered light received at the sensor is a rectangular filtered light.

25. (canceled)
